(19) United States
(12) Patent Application Publication
(10) Pub. No.: US 2024/0032166 A1
(43) Pub. Date: Jan. 25, 2024

(54) FULL-SPECTRUM LIGHT-EMITTING DIODE (LED) COLOR MANAGEMENT SYSTEM BASED ON RGBWCLA SEVEN-COLOR INTEGRATION

(71) Applicant: Shanghai SHYLON Optoelectronic Technology Co., Ltd, Shanghai (CN)

(72) Inventors: Yinghui Lu, Shanghai (CN); Liang Wei, Shanghai (CN); Zhangjun Liu, Shanghai (CN)

(21) Appl. No.: 17/973,117

(22) Filed: Oct. 25, 2022

(30) Foreign Application Priority Data
Jul. 25, 2022 (CN) 202210881360.1

(51) Int. Cl. H05B 45/20; H05B 47/11

(52) U.S. Cl. CPC H05B 45/20; H05B 47/11

(57) ABSTRACT

The present disclosure provides a full-spectrum LED color management system based on RGBWCLA seven-color integration, including an LED lamp; an aluminum substrate inside the LED lamp; a seven-color-integrated full-spectrum integrated LED light source arranged on the aluminum substrate, a lens fixed to the aluminum substrate, a color processing operation chip, a data mining extensions (DMX) communication module, a color control module, a high-precision spectral brightness detector and a color calculation software computer device. In the foregoing mode, the full-spectrum LED color management system implements the following: the seven-color lamp implements a change in simulated blackbody curve correlated color temperature (CCT) from 1,800 K to 8,000 K; the seven-color lamp implements full-spectrum output of white light, and has a color rendering index Ra of 95 or above and R9>90; and the seven-color lamp implements 240% REC.709 color gamut coverage.

### CROSS REFERENCE TO RELATED APPLICATION

This patent application claims the benefit of and priority to Chinese Patent Application No. 202210881360.1, filed with the China National Intellectual Property Administration on Jul. 25, 2022, the disclosure of which is incorporated by reference herein in its entirety as part of the present application.

### TECHNICAL FIELD

The present disclosure relates to the field of light-emitting diode (LED) lighting, and in particular, to a full-spectrum LED color management system.

### BACKGROUND

In early colored outdoor LED lamps, attention is focused on reliability, stability and cost reduction of products, and there is no more requirements for quality of colored light. Colored outdoor LED lamps can substantially meet requirements as long as the lamps reach certain brightness, are easy to control and reliable, and have cool color changes. In recent years, in a terminal market, requirements are raised for quality of light. For example, lamps are required to be able to implement a blackbody locus correlated color temperature (CCT) of 2,200 K to 8,000 K through mixing, are required to implement higher color rendering in order to restore a true color of an object, and are required to have brighter colors. These all put forward higher requirements for lamps. To meet these new requirements, colored outdoor LED lamps have developed from three primary colors of red, green and blue (RGB) to multiple primary colors of RGBW-RGBAL. A new trend of stage lighting appears in outdoor LED lamps. The new requirements inevitably cause new problems, that is, most of outdoor RGB LED lamps in the market at present cannot calibrate colors, have a small color gamut range, and cannot meet requirements for light quality.

### SUMMARY

In view of the foregoing disadvantages of the prior art, the present disclosure provides a full-spectrum LED color management system based on RGBWCLA seven-color integration, which can implement high-quality light colors and customized colors through color management.

The present disclosure relates to the technical field of LED lighting and provides a full-spectrum LED color management system based on RGBWCLA seven-color integration, including an LED lamp; an aluminum substrate inside the LED lamp; a seven-color-integrated full-spectrum integrated LED light source arranged on the aluminum substrate, a lens fixed to the aluminum substrate, a color processing operation chip, a data mining extensions (DMX) communication module, a color control module, a high-precision spectral brightness detector and a color calculation software computer device. Spectral information of a sample lamp is collected by the high-precision spectral brightness detector from light emitted by the sample lamp and is sent to the computer device by the DMX communication module, and the computer performs calculation and sends required color spectrum information by using DMX communication module to the sample lamp color control module. the test is repeated until a target color or color temperature is reached, and then data met through calculation is sent to a project lamp; computer software implements lamp coding, brightness adjustment and color adjustment by using the DMX communication module; and in the foregoing mode, the full-spectrum LED color management system implements the following: the seven-color lamp implements a change in simulated blackbody curve CCT from 1,800 K to 8,000 K; the seven-color lamp implements full-spectrum output of white light, and has a color rendering index Ra of 95 or above and R9>90; and the seven-color lamp implements 240% REC.709 color gamut coverage.

In the full-spectrum LED color management system based on RGBWCLA seven-color integration, the LED lamp, the aluminum substrate inside the LED lamp, the seven-color-integrated full-spectrum integrated LED light source arranged on the aluminum substrate, the lens fixed to the aluminum substrate, the color processing operation chip and the color control module serve as the sample lamp, where the seven-color-integrated full-spectrum integrated LED light source, the lens, the color processing operation chip and the color control module are all arranged inside the LED lamp.

In the full-spectrum LED color management system based on RGBWCLA seven-color integration, the seven-color-integrated full-spectrum integrated LED light source implements new integration of seven colors of RGBWCLA, which are three primary colors of red, green and blue (RGB), three complementary colors, and white of balancing white light.

In the full-spectrum LED color management system based on RGBWCLA seven-color integration, a control lens of the color control module is the color processing operation chip.

By using the foregoing technical solution, the present disclosure has the following beneficial effects:

Stepless adjustment of the seven-color lamp from 1,800 K to 8,000 K can be implemented, and Duv is customized.

The seven-color lamp implements full-spectrum output of white light, and has a color rendering index Ra of 95 or above and R9>90.

The seven-color lamp implements 240% REC.709 color gamut coverage.

A high 4k refresh rate without jitter is achieved, and the device supports remote device management (RDM) bidirectional feedback.

### BRIEF DESCRIPTION OF THE DRAWINGS

FIG. 1 is a flowchart of full-spectrum LED color management in an embodiment of the present disclosure;

FIG. 2 is diagram showing a comparison between seven-color integration in an embodiment of the present disclosure and conventional four-color and three-color spectra;

FIG. 3A-C are color detection diagrams after color management in an embodiment of the present disclosure;

FIG. 4 is a color temperature change curve graph in an embodiment of the present disclosure;

FIG. 5 is a diagram of a principle of a color processing operation chip in an embodiment of the present disclosure; and

FIG. 6 is a diagram of a principle of a color control module in an embodiment of the present disclosure.

### DETAILED DESCRIPTION OF THE EMBODIMENTS

The implementations of the present disclosure are described below through specific examples, and those skilled in the art can easily understand other advantages and effects of the present disclosure from the content disclosed in this specification. The present disclosure can also be implemented or applied through other different specific implementations. Based on different viewpoints and applications, various modifications or changes can be made to various details of this specification without departing from the spirit of the present disclosure. It should be noted that the following embodiments and features in the embodiments may be combined with each other provided that no conflict occurs.

It should be noted that, the drawings provided in the following embodiments merely illustrate the basic concepts of the present disclosure schematically. Therefore, the drawings only show components related to the present disclosure rather than being drawn according to the quantities, shapes, and sizes of components in actual implementation, patterns, quantities, and proportions of components in actual implementation may be changed randomly, and the component layout may be more complex.

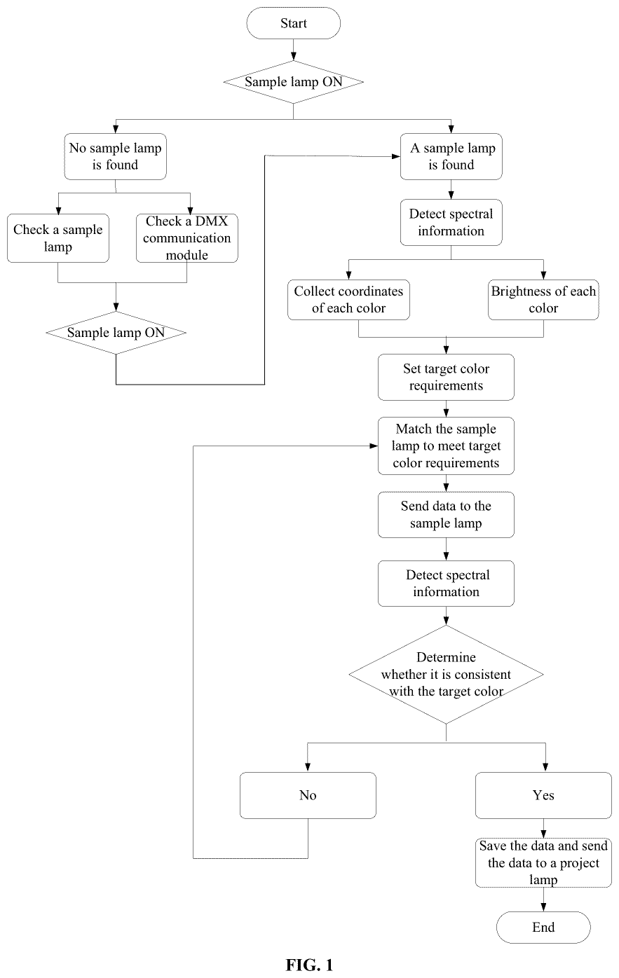

Referring to FIG. 1, the present disclosure provides a full-spectrum LED color management system, including the following specific steps.
Step 1: After a sample lamp is powered on, search for, by a computer device, the sample lamp by using a DMX communication module.
Step 2: After the computer device finds the sample lamp, collect each chromaticity coordinate and brightness of the sample lamp.
Step 3: Analyze the collected chromaticity coordinates of the sample lamp, and perform white balance correction, where, there is an obvious contrast before and after calibration.
Step 4: Analyze parameters of the sample lamp, then set a target color, and then send data to the sample lamp.
Step 5: After the sending is completed, test sample lamp chromaticity data and light quality again to determine whether a preset value is reached, and if not, repeat the foregoing steps.

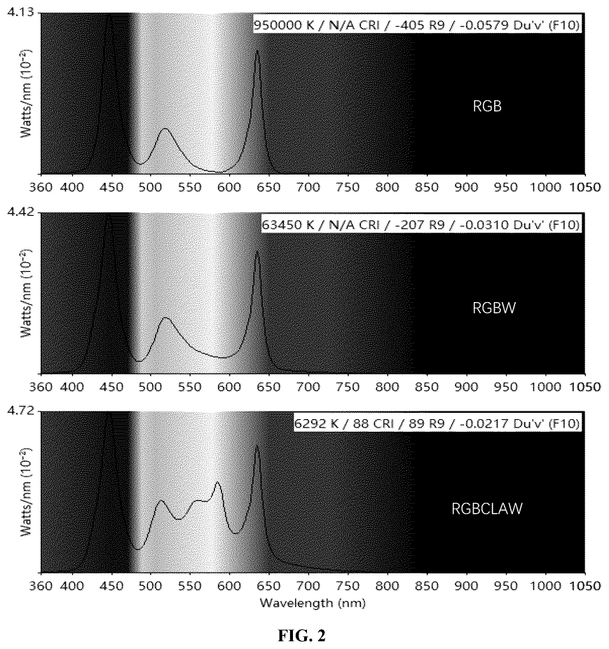

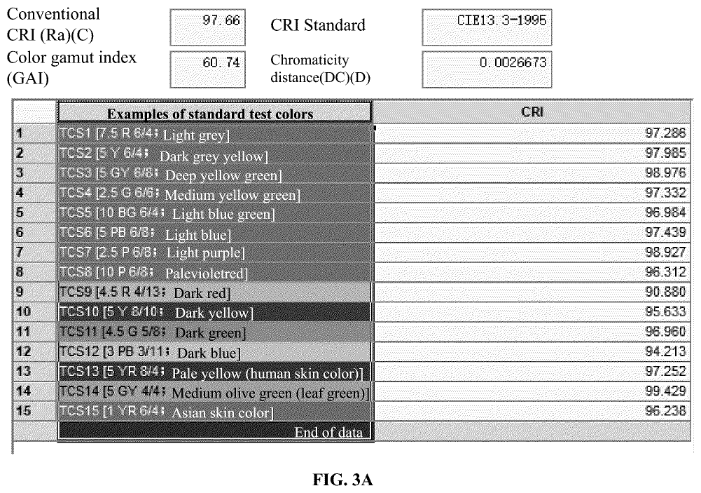

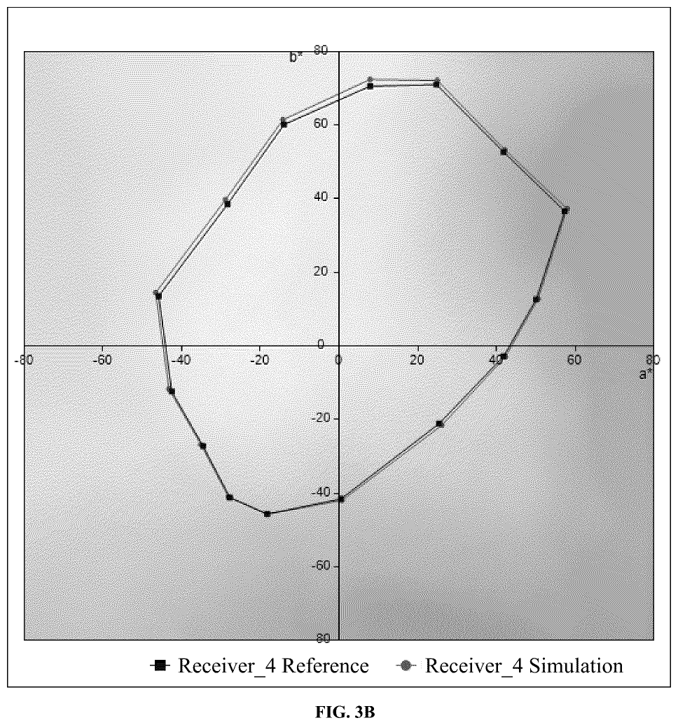

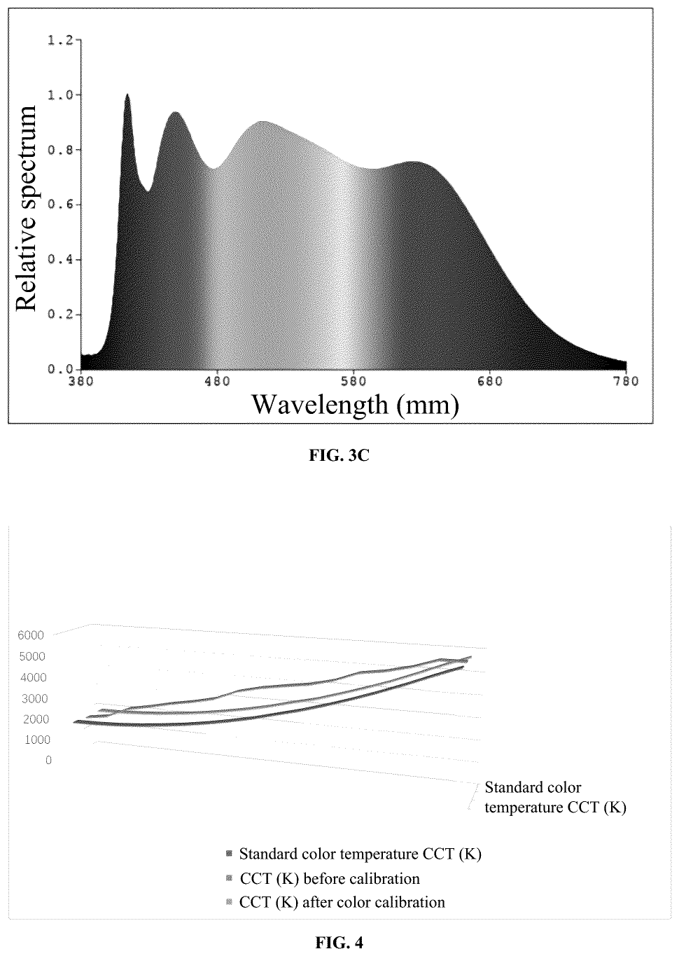

In the LED sample lamp, the a seven-color-integrated LED chip is arranged, so that the spectral data is more comprehensive and continuous than that in a case in which four colors or three colors are provided (refer to FIG. 2), which effectively ensures high color rendering after calibration and high quality of the target color.

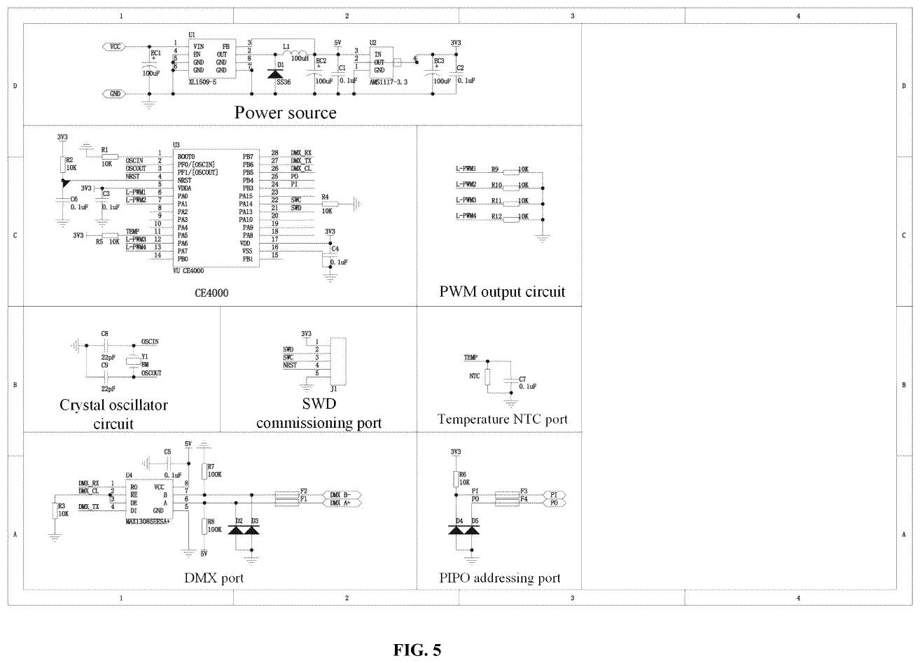

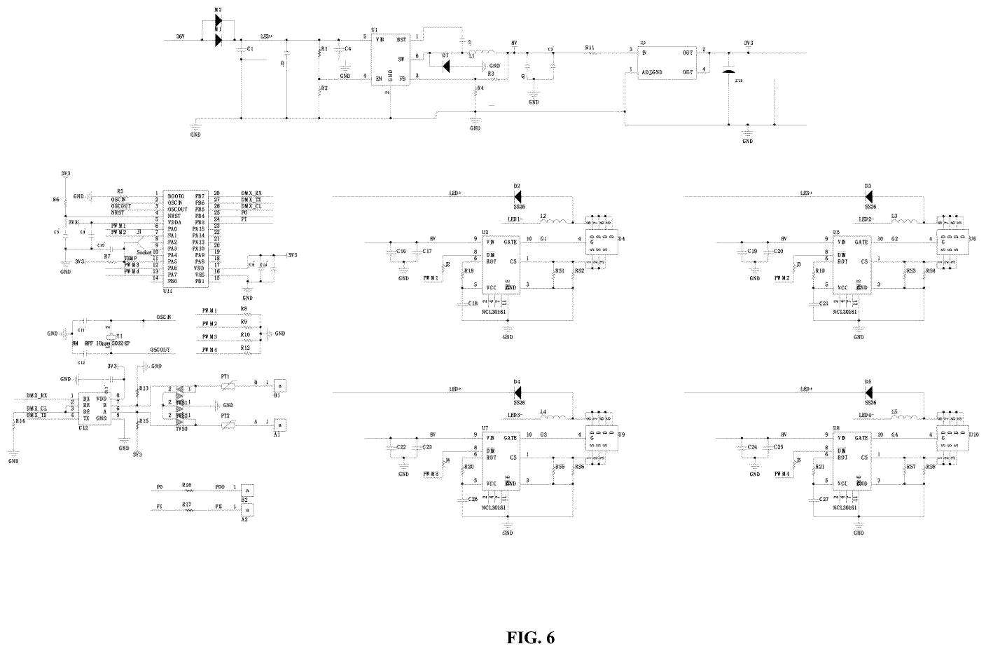

In the LED lamp, a color processing operation chip is VU SCC_CE 4301 (refer to FIG. 5), which is a core for driving a color control module (refer to FIG. 6). This ensures a high refresh rate of the LED lamp without jitter. The chip mainly has the following functions: Automatic correction of white balance linearity of the lamp is implemented by using a communication protocol of a white balance correction system. Spatial consistency and accuracy of the color temperature of the corrected lamp are ensured. In addition, RDM control is taken into account: CE4301 can perform mode conversion by using an RDM standard instruction, and read and write a DMX base address of the lamp.

The foregoing embodiments are merely intended to exemplarily explain the principles and effects of the present disclosure, rather than limit the present disclosure. Any person skilled in the art can make modifications or changes to the foregoing embodiments without departing from the spirit and scope of the present disclosure. Hence, all equivalent modifications or changes made by those of ordinary skill in the art without departing from the spirit and technical teachings disclosed in the present disclosure should fall within the scope defined by appended claims to the present disclosure.

What is claimed is:

1. A full-spectrum light-emitting diode (LED) color management system based on RGBWCLA seven-color integration, comprising an LED lamp (1), an aluminum substrate (2) inside the LED lamp, a seven-color-integrated full-spectrum integrated LED light source (3) arranged on the aluminum substrate, a lens (4) fixed to the aluminum substrate, a color processing operation chip (5), a data mining extensions (DMX) communication module (9), a color control module (6), a high-precision spectral brightness detector (7), and a color calculation software computer device (8), wherein spectral information of a sample lamp is collected by the high-precision spectral brightness detector (7) from light emitted by the sample lamp and is sent to the computer device (8) by the DMX communication module (5), and the computer performs calculation and sends required color spectrum information by using DMX communication module (9) to the sample lamp color control module (6); the test is repeated until a target color or color temperature is reached, and then data met through calculation is sent to a project lamp; computer software implements lamp coding, brightness adjustment and color adjustment by using the DMX communication module; and in the foregoing mode, the full-spectrum LED color management system implements the following: the seven-color lamp implements a change in simulated blackbody curve correlated color temperature (CCT) from 1,800 K to 8,000 K; the seven-color lamp implements full-spectrum output of white light, and has a color rendering index Ra of 95 or above and R9>90; and the seven-color lamp implements 240% REC.709 color gamut coverage.

2. The full-spectrum LED color management system based on RGBWCLA seven-color integration according to claim 1, wherein the LED lamp (1), the aluminum substrate (2) inside the LED lamp, the seven-color-integrated full-spectrum integrated LED light source (3) arranged on the aluminum substrate, the lens (4) fixed to the aluminum substrate, the color processing operation chip (5) and the color control module (6) serve as the sample lamp, wherein the seven-color-integrated full-spectrum integrated LED light source (3), the lens (4), the color processing operation chip (5) and the color control module (6) are all arranged inside the LED lamp (1).

3. The full-spectrum LED color management system based on RGBWCLA seven-color integration according to claim 1, the seven-color-integrated full-spectrum integrated LED light source implements new integration of seven colors of RGBWCLA, which are three primary colors of red, green and blue (RGB), three complementary colors (CLA), and white of balancing white light.

4. The full-spectrum LED color management system based on RGBWCLA seven-color integration according to claim 2, the seven-color-integrated full-spectrum integrated LED light source implements new integration of seven colors of RGBWCLA, which are three primary colors of red, green and blue (RGB), three complementary colors (CLA), and white of balancing white light.

5. The full-spectrum LED color management system based on RGBWCLA seven-color integration according to claim 1 wherein a control lens of the color control module (6) is the color processing operation chip (5).

6. The full-spectrum LED color management system based on RGBWCLA seven-color integration according to claim 2 wherein a control lens of the color control module (6) is the color processing operation chip (5).

7. The full-spectrum LED color management system based on RGBWCLA seven-color integration according to claim 1, wherein through calculation and simulation of the color management system, a change in simulated blackbody curve CCT of the seven-color lamp from 1,800 K to 8,000 K is implemented; the seven-color lamp implements full-spectrum output of white light, and has a color rendering index Ra of 95 or above and R9>90; and the seven-color lamp implements 240% REC.709 color gamut coverage.
